(19) United States
(12) Patent Application Publication
(10) Pub. No.: US 2009/0180088 A1
(43) Pub. Date: Jul. 16, 2009

(54) Illumination Sources for Lithography Systems

(76) Inventors: Uwe Paul Schroeder, Lake Carmel, NY (US); Klaus Herold, Poughquag, NY (US)

Correspondence Address: SLATER & MATSIL LLP, 17950 PRESTON ROAD, SUITE 1000, DALLAS, TX, 75252, US

(21) Appl. No.: 12/013,201

(22) Filed: Jan. 11, 2008

(51) Int. Cl. G03B 27/42; G03B 27/72

(52) U.S. Cl. 355/53; 355/71

(57) ABSTRACT

Illumination sources, lithography systems, and methods of processing and fabricating semiconductor devices are disclosed. In a preferred embodiment, an illumination source includes a first aperture type generator and at least one second aperture type generator. The illumination source is adapted to emit energy simultaneously from the first aperture type generator and the at least one second aperture type generator.

### TECHNICAL FIELD

The present invention relates generally to the fabrication of semiconductor devices, and more particularly to illumination sources for lithography systems.

### BACKGROUND

Generally, semiconductor devices are used in a variety of electronic applications, such as computers, cellular phones, personal computing devices, and many other applications. Home, industrial, and automotive devices that in the past comprised only mechanical components now have electronic parts that require semiconductor devices, for example.

Semiconductor devices are manufactured by depositing many different types of material layers over a semiconductor workpiece, wafer, or substrate, and patterning the various material layers using lithography. The material layers typically comprise thin films of conductive, semiconductive, and insulating materials that are patterned and etched to form integrated circuits (ICs). There may be a plurality of transistors, memory devices, switches, conductive lines, diodes, capacitors, logic circuits, and other electronic components formed on a single die or chip, for example.

Optical lithography techniques are used in the semiconductor industry to pattern and alter material layers of integrated circuits. Optical photolithography involves projecting or transmitting light to expose a layer of photosensitive material on a semiconductor workpiece through a pattern comprised of optically opaque or translucent areas and optically clear or transparent areas on a lithography mask or reticle. After development, the photosensitive material layer is then used as a mask to pattern or alter an underlying material layer of the semiconductor workpiece.

There is a trend in the semiconductor industry towards scaling down the size of integrated circuits, to meet the demands of increased performance and smaller device size. As features of semiconductor devices become smaller, lithography processes become more difficult. The use of customized illumination sources in lithography equipment is becoming more predominant as projection lithography is required to operate at smaller dimensions. However, ordering and installing such customized illumination sources requires time and increases technology development cycles. Furthermore, simulation is used to define customized illumination sources, and the simulation outcome might not be as predicted. Thus, several cycles of aperture reorders have to be planned into a technology development cycle.

Custom illumination sources may be emulated by double exposure techniques, by using the same mask and overlaying different aperture shapes. However, wafer results can be affected by longer post exposure delay times. Furthermore, the emulation functions as an approximation, because cross-talk between the two illumination modes is not considered. As a result, the prediction of optimized pupil shapes can be erroneous. In addition, two exposure steps and other additional processing steps are required, increasing fabrication time.

Thus, what are needed in the art are improved lithography systems and methods for patterning and processing material layers of semiconductor devices.

### SUMMARY OF THE INVENTION

These and other problems are generally solved or circumvented, and technical advantages are generally achieved, by preferred embodiments of the present invention, which provide novel illumination sources for lithography systems.

In accordance with a preferred embodiment of the present invention, an illumination source includes a first aperture type generator and at least one second aperture type generator. The illumination source is adapted to emit energy simultaneously from the first aperture type generator and the at least one second aperture type generator.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of an illumination source having a first aperture type generator and at least one second aperture type generator in accordance with an embodiment of the present invention;

FIG. 2 is a more detailed block diagram of an illumination source in accordance with an embodiment of the present invention, wherein an energy diverter diverts energy from an energy source towards the first and second aperture type generators, and an energy converger converges energy emitted from the first and second aperture type generators;

FIG. 3 shows a lithography system implementing the novel illumination sources described herein;

FIG. 4a shows a first pupil shape comprising a quadrapole shape emitted by a first aperture type generator in accordance with an embodiment of the present invention;

FIG. 4b shows a second pupil shape comprising an annular shape emitted by a second aperture type generator in accordance with an embodiment of the present invention;

FIG. 4c shows the converged energy from the first and second aperture type generators of FIGS. 4a and 4b;

FIG. 5a shows a first pupil shape comprising a first quadrapole shape emitted by a first aperture type generator in accordance with an embodiment of the present invention;

FIG. 5b shows a second pupil shape comprising a second quadrapole shape emitted by a second aperture type generator in accordance with an embodiment of the present invention;

FIG. 5c shows a third pupil shape comprising a single beam shape emitted by a third aperture type generator in accordance with an embodiment of the present invention;

FIG. 5d shows the converged energy from the first, second, and third aperture type generators of FIGS. 5a, 5b, and 5c;

FIG. 6a shows a first pupil shape comprising a first annular shape emitted by a first aperture type generator in accordance with an embodiment of the present invention;

FIG. 6b shows a second pupil shape comprising a second annular shape emitted by a second aperture type generator in accordance with an embodiment of the present invention;

FIG. 6c shows the converged energy from the first and second aperture type generators of FIGS. 6a and 6b; and

FIGS. 7, 8, and 9 show cross-sectional views of a method of processing a semiconductor device at various stages using a lithography system including the novel illumination sources described herein.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that embodiments of the present invention provide many applicable inventive concepts that can be embodied in a wide variety of specific contexts. The specific embodiments discussed are merely illustrative of specific ways to make and use the invention, and do not limit the scope of the invention.

As critical dimensions of advanced generation technology nodes decrease, which is the trend in the semiconductor industry, special shaped illumination apertures are needed in lithography processes. However, conventional exposure tools comprise illuminators that only have a few number of illumination settings. An illuminator may include a rotatable canister with a fixed number of mechanical apertures that each provide an illumination setting. The mechanical apertures comprise aperture shapes such as circular, annular, quadrapole, dipole, or single pole. A rotatable canister of mechanical apertures typically comprises about five aperture opening designs, for example. However, the number of illumination apertures in conventional illuminators is fixed and cannot be freely varied. Furthermore, only one aperture opening may be used at a time.

In some lithography systems, only a single diffractive optic element (DOE) is used. The use of customized illumination sources is a recent trend, which is costly and adds to the cycle time. In some semiconductor device applications, a layer of photoresist is exposed twice with two different aperture types to achieve the desired pattern. However, this requires two separate exposure processes, which reduces the productivity and decreases throughput of the manufacturing process.

Embodiments of the present invention achieve technical advantages by providing novel illumination sources for illumination systems. The illumination sources allow the use of two apertures simultaneously in an optical delivery system. Two or more types of illumination sources are combined into a single custom shaped source, eliminating costs and time associated with ordering illumination sources having custom apertures. The novel illumination sources include two or more aperture type generators. The illumination systems are adapted to provide combinations or multiple sizes of circular, annular, quadrapole, dipole, and/or single pole illumination aperture shapes for a single exposure process, to be described further herein.

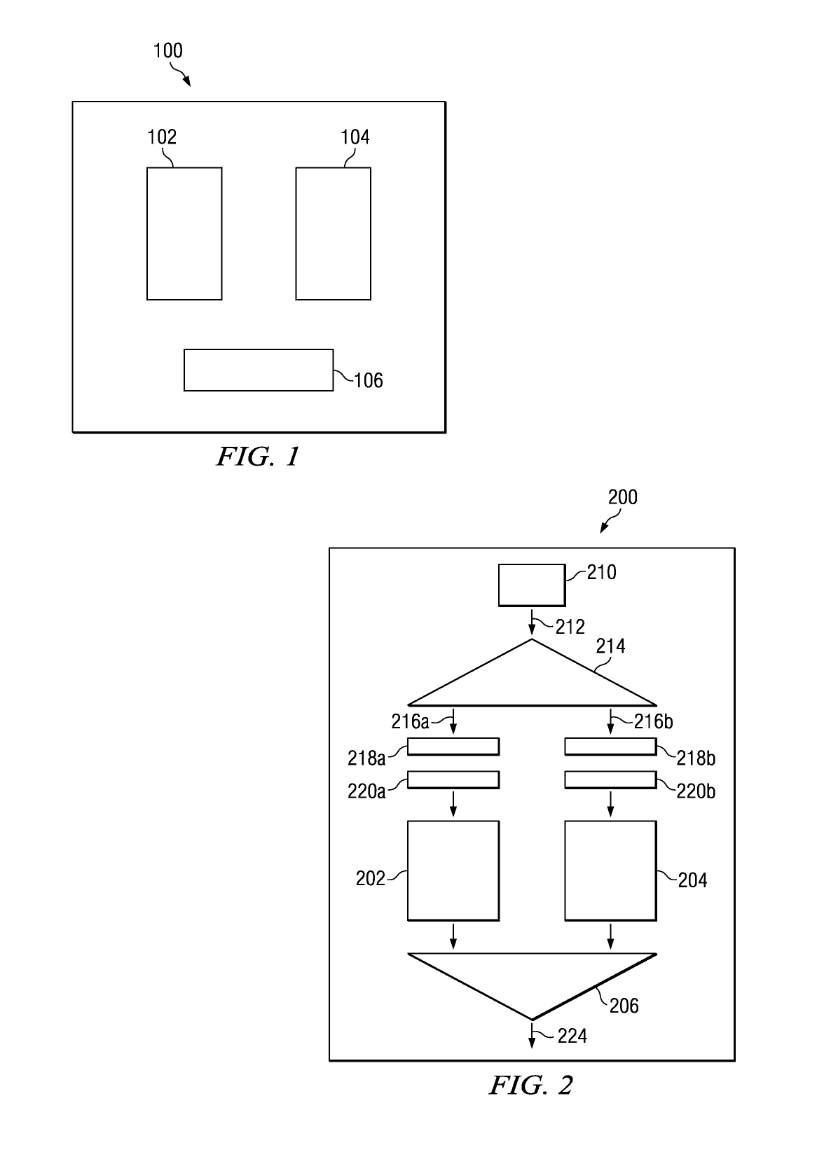

FIG. 1 is a block diagram of an illumination source 100 including a first aperture type generator 102 and at least one second aperture type generator 104 in accordance with an embodiment of the present invention. Only one second aperture type generator 104 is shown in FIG. 1; however, the illumination source 100 may include two or more second aperture type generators 104, for example.

The first aperture type generator 102 is adapted to generate a first aperture type, and the at least one second aperture type generator 104 is adapted to generate at least one second aperture type. The at least one second aperture type may have a different shape or size than the first aperture type. The first aperture type generator 102 may comprise a first diffractive optics element (DOE), and the at least one second aperture type generator 104 may comprise at least one second DOE, the at least one second DOE being different than the first DOE, for example.

The first aperture type generator 102 is adapted to emit a first pupil shape, and the at least one second aperture type generator 104 is adapted to emit at least one second pupil shape, the at least one second pupil shape being a different shape or size than the first pupil shape. The first pupil shape and the at least one second pupil shape may comprise a dipole shape, a quadrapole shape, an annular shape, a single beam shape, a multiple beam shape, a plurality of sizes thereof, and/or combinations thereof, as examples, although other shapes may also be used.

The illumination source 100 is adapted to emit energy simultaneously from the first aperture type generator 102 and the at least one second aperture type generator 104. The illumination source 100 includes an aperture type converger 106 proximate the first aperture type generator 102 and the at least one second aperture type generator 104. The aperture type converger 106 comprises an energy converger adapted to converge energy emitted from the first aperture type generator 102 and the at least one second aperture type generator 104. For example, the aperture type converger 106 is adapted to converge energy emitted from the first aperture type generator 102 with energy emitted from the at least one second aperture type generator 104. The aperture type converger 106 may comprise a beam converger, for example.

FIG. 2 is a more detailed block diagram of an illumination source 200 in accordance with an embodiment of the present invention, wherein an energy diverter 214 diverts energy 212 from an energy source 210 towards the first and second aperture type generators 202 and 204, and an energy converger 206 converges energy emitted from the first and second aperture type generators 202 and 204. Like numerals are used for the various elements that were used to describe FIG. 1. To avoid repetition, each reference number shown in FIG. 2 is not described again in detail herein. Rather, similar materials and elements x02, x04, x06, etc. . . . are preferably used for the various materials and elements shown as were described for FIG. 1, where x=1 in FIG. 1 and x=2 in FIG. 2.

The illumination source 200 includes an energy source 210 adapted to emit energy 212 which may comprise light in the form of a laser beam, for example, although alternatively, other forms of energy may also be used. The energy source 210 may comprise a mercury-vapor lamp, an excimer laser using krypton fluoride (KrF), or argon fluoride (ArF), or combinations thereof, as examples, although other light or energy sources may also be used. The energy source 210 may comprise a laser and beam delivery system, for example. The energy 212 comprises a single beam that is directed towards the energy diverter 214.

The energy diverter 214 may comprise a beam splitter adapted to split the energy 212 beam into two or more separate beams of energy 216a and 216b. The energy diverter 214 is adapted to divert a first portion 216a of energy 212 from the energy source 210 towards the first aperture type generator 202 and to divert at least one second portion 216b of energy 212 from the energy source 210 towards the at least one second aperture type generator 204. The energy diverter 214 may be adapted to split the energy 212 from the source 210 into two beams of energy 216a and 216b comprising substantially the same magnitude or intensity, or alternatively, the energy 216a and 216b beams may have different magnitudes or intensities.

The illumination source 200 may include optional grey filters 218a and 218b and/or optional polarization filters 220a and 220b disposed between the energy diverter 212 and the aperture type generators 202 and 204, as shown in FIG. 2. A first grey filter 218a may be disposed between the energy source 210 and the first aperture type generator 202, and at least one second grey filter 218b may be disposed between the energy source 210 and the at least one second aperture type generator 204. A first polarization filter 220a may be disposed between the energy source 210 and the first aperture type generator 202, and at least one second polarization filter 220b may be disposed between the energy source 210 and the at least one second aperture type generator 204.

For example, energy 216a may be emitted from the energy diverter 214 through a first grey filter 218a and a first polarizing filter 220a and then to the first aperture type generator 202. Energy 216b may be emitted from the energy diverter 214 through at least one second grey filter 218b and at least one second polarizing filter 220b and then to the at least one second aperture type generator 204. The optional grey filters 218a and 218b may be used to control the intensity, magnitude, or amount of energy emitted from the first aperture type generator 202 and the at least one second aperture type generator 204, respectively, for example. The optional polarization filters 220a and 220b may be used to alter and control the polarization of energy or light emitted from the first and second aperture type generators 202 and 204, for example. The intensity and polarization state of energy emitted from the first and second aperture type generators 202 and 204 may be split at any rate between the two or more aperture type generators 202 and 204, providing the ability to highly customize the illumination source 200.

The energy converger 206 converges energy emitted from the first aperture type generator 202 and the at least one second aperture type generator 204, producing a single beam of energy 224 that comprises a combined aperture type or pupil shape. The energy converger 206 may comprise a beam converger, for example.

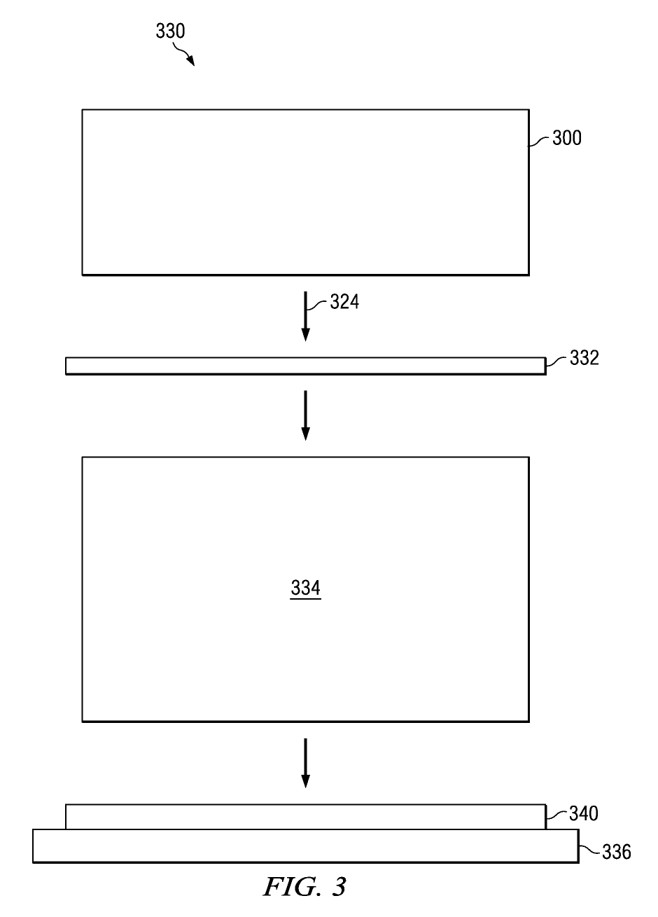

FIG. 3 shows a lithography system 330 implementing a novel illumination source 300 described herein. Again, like numerals are used for elements as were used in the previous figures, and to avoid repetition, each element number is not described in detail herein again. The lithography system 330 may comprise a microlithography exposure tool including the novel illumination source 300, for example. The lithography system 330 is shown processing a semiconductor device 340 in accordance with an embodiment of the present invention. The lithography system 330 includes an illumination source 300 such as illumination sources 100 and 200 shown in FIGS. 1 and 2, a lithography mask or reticle 332, a projection lens system 334, and a support or wafer stage 336 for the semiconductor device 340.

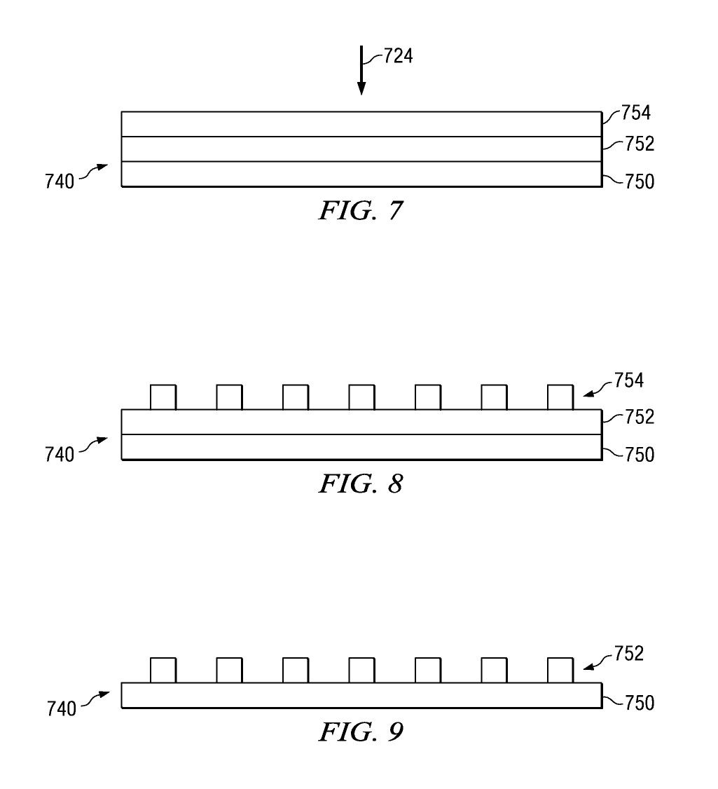

The projection lens system 334 is disposed proximate the illumination source 300. The lithography mask 332 comprising a pattern to be transferred to the semiconductor device 340 is disposed between the projection lens system 334 and the illumination source 300. The projection lens system 334 comprises a plurality of lenses (not shown) and is adapted to project an image from the lithography mask 332 onto a layer of photosensitive material, such as a layer of photoresist of the semiconductor device 340. The semiconductor device 340 may include a workpiece, wafer, or substrate having a material layer (not shown in FIG. 3; see FIGS. 7, 8, and 9 at 752) disposed thereon that will be patterned using the layer of photosensitive material as a mask, for example.

Energy or light 324 from the illuminator 300 is directed towards the semiconductor device 340 (e.g., towards the support 336 for the semiconductor device 340) through the mask 332 and the projection lens system 334, as shown, along an optical path. The energy or light 324 is re-converged by the projection lens system 334 onto the layer of photosensitive material on the semiconductor device 340 such that a latent image of the mask 332 is reproduced onto the layer of photosensitive material of the semiconductor device 340. The layer of photosensitive material is developed, and unexposed (or exposed, depending on whether the resist is negative or positive, respectively) resist is removed, leaving behind a patterned layer of photosensitive material. The patterned layer of photosensitive material is then used as a mask while a portion of the semiconductor device 340 is altered.

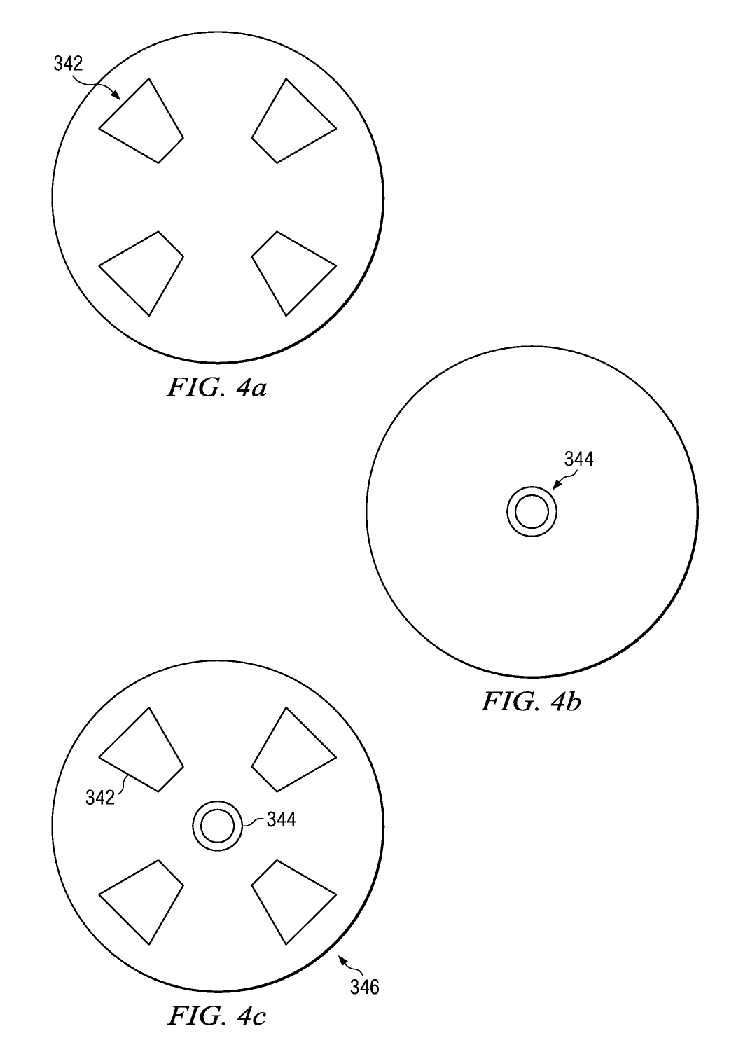

In accordance with embodiments of the present invention, at least two different beam shapes are produced by the two or more aperture type generators 202 and 204 shown in FIG. 2. The beam shapes may comprise different shapes or sizes. FIGS. 4a through 4c, FIGS. 5a through 5d, and FIGS. 6a through 6c show some examples of beam shapes that are producible using the novel illumination sources 100, 200, and 300 described herein.

For example, FIG. 4a shows a first pupil shape 342 comprising a quadrapole shape emitted by a first aperture type generator (e.g., first aperture type generator 202 shown in FIG. 2) in accordance with an embodiment of the present invention. FIG. 4b shows a second pupil shape 344 comprising an annular shape emitted by a second aperture type generator 204 in accordance with an embodiment of the present invention. FIG. 4c shows the converged energy 224 from the first and second aperture type generators 202 and 204 shown in FIGS. 4a and 4b. The converged energy 224 comprises a pattern 346 comprising the quadrapole shape 342 combined with the annular shape 344 in a central region of the quadrapole pattern.

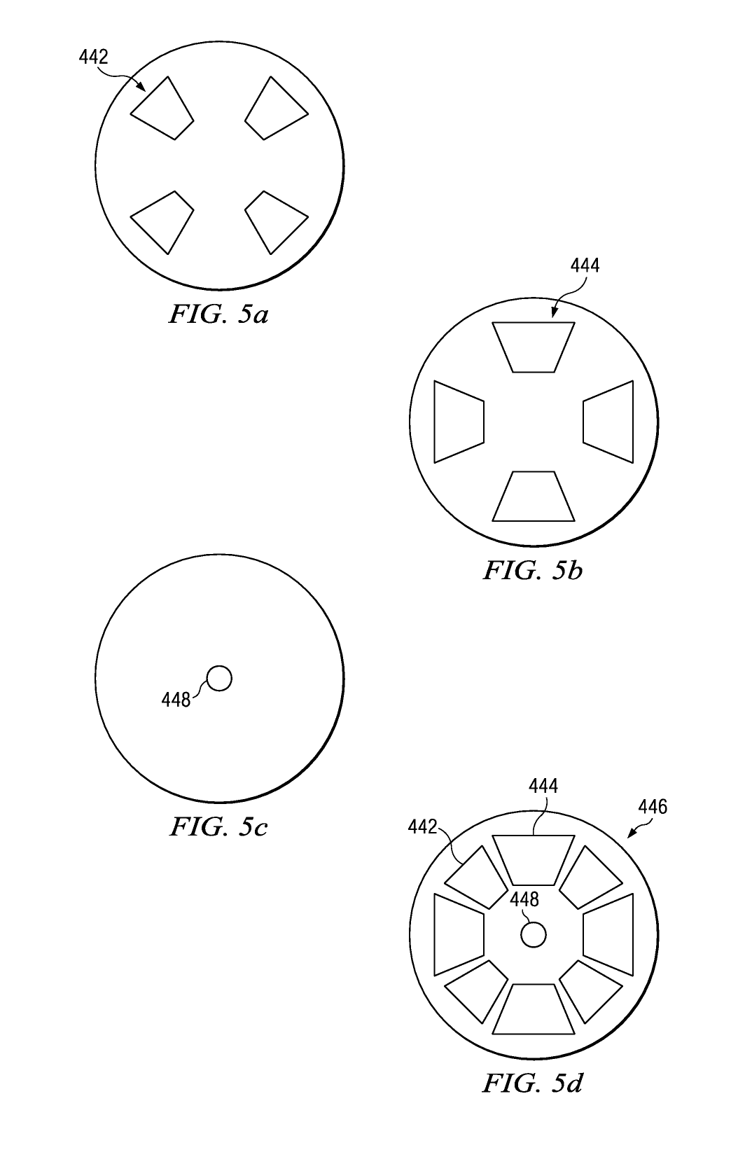

As another example, FIG. 5a shows a first pupil shape 442 comprising a first quadrapole shape emitted by a first aperture type generator 202 in accordance with an embodiment of the present invention. FIG. 5b shows a second pupil shape 444 comprising a second quadrapole shape emitted by a second aperture type generator 204 in accordance with an embodiment of the present invention. FIG. 5c shows a third pupil shape 448 comprising a single beam shape emitted by a third aperture type generator (e.g., another second aperture type generator 204) in accordance with an embodiment of the present invention. FIG. 5d shows the converged energy 224 from the first, second, and third aperture type generators of FIGS. 5a, 5b, and 5c. The converged energy 224 comprises a pattern 446 including the two quadrapole shapes 442 and 444 and the single beam shape 448 in a central region of the quadrapole shapes 442 and 444.

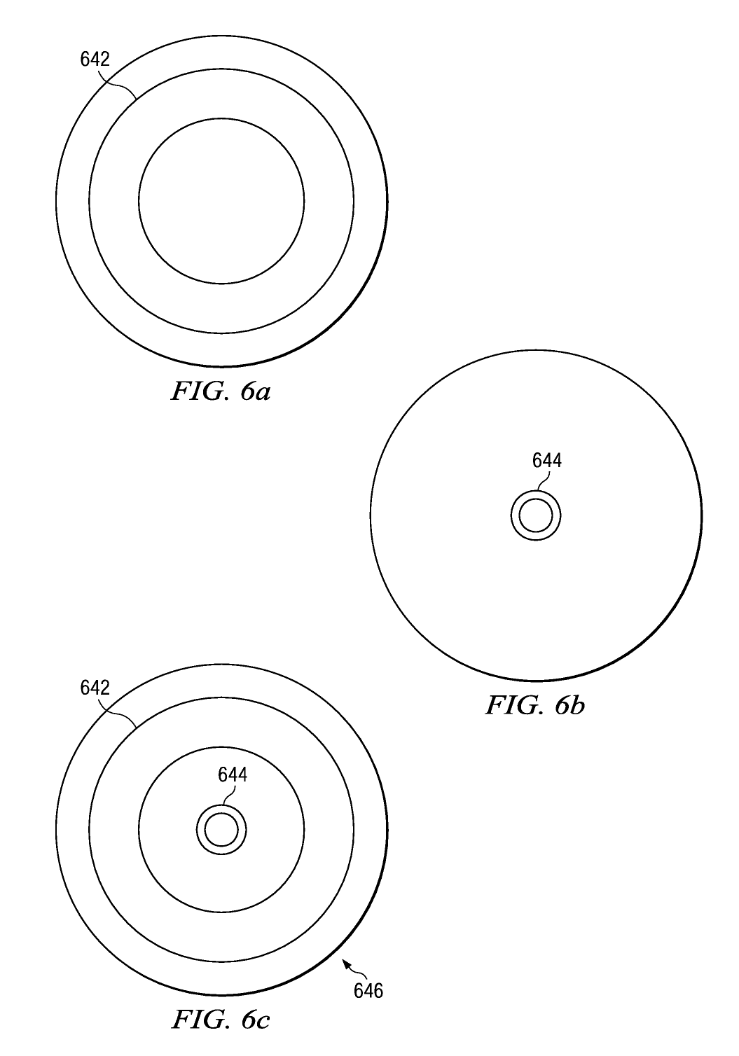

As yet another example, FIG. 6a shows a first pupil shape 642 comprising a first annular shape emitted by a first aperture type generator 202 in accordance with an embodiment of the present invention. FIG. 6b shows a second pupil shape 644 comprising a second annular shape emitted by a second aperture type generator 204 in accordance with an embodiment of the present invention. FIG. 6c shows the converged energy 224 from the first and second aperture type generators 202 and 204 of FIGS. 6a and 6b. The converged energy 224 beam shape comprises a pattern 646 comprising the two concentric annular beams 642 and 644.

The examples shown in FIGS. 4a through 6c are merely exemplary; other combinations of different sizes and shapes of aperture type generators 202 and 204 may be used to produce converged energy 224 beam shapes comprising many other combinations and patterns. Advantageously, the energy patterns produced by the multiple aperture type generators 202 and 204 of embodiments of the present invention may be designed, selected, and customized according to the requirements for a particular semiconductor device 340, photoresist, lithography system 330, and lithography process, for example.

Embodiments of the present invention may be used to provide a wide variety of illumination aperture shapes using a single illumination source 100, 200, and 300. Many combinations of illumination aperture configurations may be produced using the novel illumination source 100, 200, and 300 described herein. A single exposure process may be used, eliminating the need for double or multiple exposures, increasing throughput time in the manufacturing process of semiconductor devices 340.

FIGS. 7, 8, and 9 show cross-sectional views of a method of processing a semiconductor device 740 at various stages using a lithography system (such as system 330 shown in FIG. 3) including the novel illumination sources 100, 200, and 300 described herein. FIG. 7 shows a semiconductor device 740 having a layer of photoresist 754 disposed thereon that is patterned using the lithography system 330 shown in FIG. 3 including the novel illumination source 300 in accordance with embodiments of the present invention. After the exposure process, the pattern in the layer of photoresist 754 comprises a latent pattern, which is then developed to form a pattern in the layer of photoresist 754, as shown in FIG. 8. FIG. 9 shows the semiconductor device 740 of FIG. 8 after the layer of photoresist 754 has been used to pattern a material layer 752 of the semiconductor device 740, e.g., using an etch process, and after the layer of photoresist 754 has been removed.

Embodiments of the present invention include methods of processing semiconductor devices 740 using the novel illumination sources 100, 200, and 300 described herein. For example, referring again to FIGS. 7 through 9 and also to FIGS. 2 and 3, in accordance with an embodiment of the present invention, a method of processing a semiconductor device 740 includes providing a workpiece 750, the workpiece 750 including a layer of photosensitive material 754 disposed thereon. The method includes providing the lithography system 330 shown in FIG. 3, the lithography system 330 including an illumination source 300 comprising a first aperture type generator 202 and at least one second aperture type generator 204, the illumination source 300 being adapted to emit energy simultaneously from the first aperture type generator 202 and the at least one second aperture type generator 204. A lithography mask 332 is disposed between the illumination source 300 of the lithography system 330 and the workpiece 750 (see FIG. 7). The method includes patterning the layer of photosensitive material 754 using the lithography mask 332 and the lithography system 330.

In some embodiments, patterning the layer of photosensitive material 754 may comprise emitting a first pupil shape from the first aperture type generator 202 and emitting at least one second pupil shape from the at least one second aperture type generator 204, the at least one second pupil shape being a different shape or size than the first pupil shape. Patterning the layer of photosensitive material 754 may further comprise converging the first pupil shape with the at least one second pupil shape, for example. The first pupil shape and the at least one second pupil shape may comprise a dipole shape, a quadrapole shape, an annular shape, a single beam shape, a multiple beam shape, a plurality of sizes thereof, and/or combinations thereof, as examples, although alternatively, other shapes may also be used.

Patterning the layer of photosensitive material 754 may further comprise controlling an intensity of the first pupil shape and the at least one second pupil shape, e.g., using the grey filters 218a and 218b shown in FIG. 2 or by using the energy diverter 214. In some applications, it may be advantageous for one pupil shape to have a greater amount of intensity than the other pupil shape; e.g., an intensity of about 20 to 80% may be used for the energy emitted from the first aperture type generator 202, and an intensity of about 80 to 20% may be used for the energy emitted from the at least one second aperture type generator 204. In some embodiments, it may be advantageous to divide the energy 212 emitted from the energy source 210, e.g., using the energy diverger 214 or other control means such as the grey filters 216a and 216b, by about 40/60%, as another example. The polarization of the first pupil shape and the at least one second pupil shape may also be controlled or altered using optional polarization filters 220a and 220b, for example.

In some embodiments, a method of processing the semiconductor device 740 may include fabricating a semiconductor device 740. The workpiece 750 may include a material layer 752 to be altered formed thereon, and a layer of photosensitive material 754 may be disposed over the material layer 752, as shown in FIG. 7. Alternatively, the workpiece 750 may be altered using the layer of photosensitive material 754 as a mask, for example (e.g., a top portion of the workpiece 750 comprises the material layer to be altered in this embodiment). The method may further include using the layer of photosensitive material 754 as a mask to alter the material layer 752, and then the layer of photosensitive material 754 is removed.

Altering the material layer 752 of the workpiece 750 may include removing at least a portion of the material layer 752, as shown in FIGS. 8 and 9. Alternatively, altering the material layer 752 of the workpiece 750 may comprise implanting the material layer 752 with a substance (such as a dopant or element), growing a substance on the material layer 752, or depositing a substance on the material layer 752, as examples, not shown in the drawings. The material layer 752 may also be altered in other ways. The material layer 752 of the workpiece 750 may comprise a conductive material, an insulating material, a semiconductive material, or multiple layers or combinations thereof, as examples.

Embodiments of the present invention also include semiconductor devices 740 patterned or altered using the novel illumination sources 100, 200, and 300, methods, and lithography systems 330 described herein, for example.

Embodiments of the present invention are advantageous when used in lithography systems 330 shown in FIG. 3 such as deep ultraviolet (DUV) lithography systems, immersion lithography systems, or other lithography systems 330 that use visible light for illumination, as examples. Embodiments of the present invention may be implemented in lithography systems, steppers, scanners, step-and-scan exposure tools, or other exposure tools, as examples. The embodiments described herein are implementable in lithography systems 330 that use refractive optics, for example. Embodiments of the present invention may also have useful application in lithography systems that utilize extreme ultraviolet (EUV) light and reflective optics.

Features of semiconductor devices 740 patterned using the novel illumination sources 100, 200, and 300, lithography systems 330, and processing methods described herein may comprise contacts, transistor gates, conductive lines, vias, capacitor plates, and other features, as examples. Embodiments of the present invention may be used to pattern features of memory devices, logic circuitry, and/or power circuitry, as examples, although other types of ICs may also be fabricated using the novel illumination sources 100, 200, and 300, lithography systems 330, and processing methods described herein.

The novel illumination sources 100, 200, and 300, lithography systems 330, and processing methods are beneficial and have useful application in technical fields other than lithography of semiconductor devices, e.g., in other applications wherein a beam of energy transmitted in different patterns is required, for example.

Advantages of embodiments of the present invention include providing novel illumination sources 100, 200, and 300, lithography systems 330, and methods for fabricating and processing semiconductor devices 740. Two or more aperture types 202 and 204 are used simultaneously in the optical delivery system. The two or more aperture types or shapes are combined or converged into one custom shaped source, eliminating costs and time associated with ordering custom apertures. Furthermore, intensity and polarization state may be split at any rate between the two or more aperture shapes, providing a highly customized optical illumination source 100, 200, or 300. Matching between multiple lithography tools is improved due to the higher number of parameters that may be adjusted, for example, in accordance with embodiments of the present invention.

Embodiments of the present invention provide a high degree of freedom in realizing a large variety and number of shapes of illumination apertures types for use in a single exposure step. Embodiments of the present invention ease the implementation of customized apertures. Two or more different aperture types and shapes may be combined and used in a single exposure process, depending on the desired exposure results, for example.

A different illumination aperture type may be used for various material layers and processing steps in the manufacture of a particular semiconductor device 740, by altering the intensities of the aperture types or by selecting different aperture types, e.g., if three or more aperture type generators 202 and 204 are included in the illumination sources 100, 200, and 300. The illumination sources 100, 200, and 300 may further be customized by varying the intensity ratio and polarization states. The dose split of energy from the first and second aperture type generators 202 and 204 may be optimized to achieve the desired performance.

Advantageously, a single exposure step and a single lithography mask may be used to achieve the same or comparable results resulting from a multiple exposure process, in accordance with some embodiments of the present invention.

On axis (e.g., a single beam of energy) and/or off-axis (annular, dipole, or quadrapole) illumination modes may be used and/or combined using the aperture type generators 202 and 204 to utilize complementary characteristics of different illumination modes, for example. Weaker areas of one illumination mode (e.g., one pupil shape) may be improved using the other illumination mode (e.g., another pupil shape).

More flexible illumination sources 100, 200, and 300 and illumination systems 330 are achieved with the combined aperture types provided by embodiments of the present invention. The novel illumination sources 100, 200, and 300 described herein may advantageously be customized according to the types of features being patterned, e.g., semi-isolated, isolated, nested, or combinations thereof.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An illumination source, comprising:
a first aperture type generator; and
at least one second aperture type generator, wherein the illumination source is adapted to emit energy simultaneously from the first aperture type generator and the at least one second aperture type generator.

2. The illumination source according to claim 1, further comprising an aperture type converger proximate the first aperture type generator and the at least one second aperture type generator.

3. The illumination source according to claim 1, wherein the first aperture type generator is adapted to generate a first aperture type, and wherein the at least one second aperture type generator is adapted to generate at least one second aperture type, the at least one second aperture type having a different shape or size than the first aperture type.

4. The illumination source according to claim 1, further comprising an energy source proximate the first aperture type generator and the at least one second aperture type generator.

5. The illumination source according to claim 4, further comprising a first grey filter disposed between the energy source and the first aperture type generator, and at least one second grey filter disposed between the energy source and the at least one second aperture type generator.

6. The illumination source according to claim 4, further comprising a first polarization filter disposed between the energy source and the first aperture type generator, and at least one second polarization filter disposed between the energy source and the at least one second aperture type generator.

7. A lithography system, comprising:
an illumination source comprising a first aperture type generator and at least one second aperture type generator, the illumination source being adapted to emit energy simultaneously from the first aperture type generator and the at least one second aperture type generator;
a support for a semiconductor workpiece;
a projection lens system disposed between the support for the semiconductor workpiece and the illumination source; and
a lithography mask disposed between the illumination source and the projection lens system.

8. The lithography system according to claim 7, wherein the illumination source comprises an energy source and an energy diverter adapted to divert a first portion of energy from the energy source towards the first aperture type generator and to divert at least one second portion of energy from the energy source towards the at least one second aperture type generator.

9. The lithography system according to claim 8, wherein the illumination source further comprises an energy converger adapted to converge energy emitted from the first aperture type generator and the at least one second aperture type generator.

10. The lithography system according to claim 7, further comprising a controller adapted to control an amount of energy emitted from the first aperture type generator or the at least one second aperture type generator.

11. The lithography system according to claim 7, wherein the first aperture type generator comprises a first diffractive optics element (DOE), and wherein the at least one second aperture type generator comprises at least one second DOE.

12. A method of processing a semiconductor device, the method including:
providing a workpiece, the workpiece including a layer of photosensitive material disposed thereon;
providing a lithography system, the lithography system including an illumination source comprising a first aperture type generator and at least one second aperture type generator, the illumination source being adapted to emit energy simultaneously from the first aperture type generator and the at least one second aperture type generator;
disposing a lithography mask between the illumination source of the lithography system and the workpiece; and
patterning the layer of photosensitive material using the lithography mask and the lithography system.

13. The method according to claim 12, wherein patterning the layer of photosensitive material comprises emitting a first pupil shape from the first aperture type generator and emitting at least one second pupil shape from the at least one second aperture type generator, the at least one second pupil shape being a different shape or size than the first pupil shape.

14. The method according to claim 13, wherein patterning the layer of photosensitive material further comprises converging the first pupil shape with the at least one second pupil shape.

15. The method according to claim 13, wherein patterning the layer of photosensitive material further comprises controlling or altering an intensity of the first pupil shape and the at least one second pupil shape.

16. The method according to claim 13, wherein patterning the layer of photosensitive material comprises emitting a first pupil shape and at least one second pupil shape comprising a dipole shape, a quadrapole shape, an annular shape, a single beam shape, a multiple beam shape, a plurality of sizes thereof, and/or combinations thereof.

17. The method according to claim 13, wherein patterning the layer of photosensitive material further comprises controlling or altering a polarization of the first pupil shape and the at least one second pupil shape.

18. A method of fabricating a semiconductor device, the method including:
providing a workpiece, the workpiece including a material layer to be altered disposed thereon and a layer of photosensitive material disposed over the material layer;
providing a lithography system, the lithography system including an illumination source comprising a first aperture type generator and at least one second aperture type generator, the illumination source being adapted to emit energy simultaneously from the first aperture type generator and the at least one second aperture type generator;
disposing a lithography mask between the illumination source of the lithography system and the workpiece;
patterning the layer of photosensitive material using the lithography mask and the lithography system by emitting energy from the first aperture type generator and the at least one second aperture type generator and converging the energy to a combined aperture shape;
using the layer of photosensitive material as a mask to alter the material layer of the workpiece; and
removing the layer of photosensitive material from the workpiece.

19. The method according to claim 18, wherein altering the material layer of the workpiece comprises removing at least a portion of the material layer, implanting the material layer with a substance, growing a substance on the material layer, or depositing a substance on the material layer.

20. The method according to claim 19, wherein the material layer of the workpiece comprises a conductive material, an insulating material, a semiconductive material, or multiple layers or combinations thereof.

21. A semiconductor device manufactured in accordance with the method of claim 20.
